(19) United States
(12) Patent Application Publication
(10) Pub. No.: US 2026/0095698 A1
(43) Pub. Date: Apr. 2, 2026

(54) AUDIO SYSTEM

(71) Applicant: ALPS ALPINE CO., LTD., Tokyo (JP)

(72) Inventors: Hiroyuki TAGUCHI, Fukushima (JP); Ryo ITO, Fukushima (JP); Yuji SAITO, Fukushima (JP)

(21) Appl. No.: 19/342,997

(22) Filed: Sep. 29, 2025

(30) Foreign Application Priority Data
Oct. 2, 2024 (JP) 2024-173219

(51) Int. Cl. H04R 3/12; H04R 5/02; H04R 5/027; H04R 5/04

(52) U.S. Cl. CPC H04R 3/12; H04R 5/023; H04R 5/027; H04R 5/04; H04R 2499/13; H04S 2420/01

(57) ABSTRACT

Audio signal processing circuitry in an audio system: extracts a cross-talk signal, which is a component of a second audio signal included in an output of a microphone; extracts a noise signal from the output of the microphone, not including the component of the second audio signal or component of sound emitted from a first-seat speaker, and including a noise component unrelated to the audio system; determines the amount of gain adjustment for a masking noise signal such that the masking noise signal is at a predetermined level greater than the difference in magnitude between the cross-talk signal and the noise signal; adjusts the gain of the masking noise signal output from a masking noise source based on the determined amount; and combines the gain-adjusted masking noise signal and the first audio signal output from a first-seat audio source together, and outputs the combined signal to the first-seat speaker.

### CROSS-REFERENCE TO RELATED APPLICATION

This application is based on and claims priority to Japanese Patent Application No. 2024-173219, filed on Oct. 2, 2024, the entire content of which is incorporated herein by reference.

### BACKGROUND OF THE INVENTION

### 1. Field of the Invention

The present disclosure relates to an audio system.

### 2. Description of the Related Art

As a technology that allows for sound field control whereby a target sound is heard only by an intended listener/user and cannot be heard by others, according to one example of such technology, a target sound is emitted from a speaker in a first area where an intended listener/user is present, while, in a second area where, for example, other unintended listeners/users not wanting to hear the target sound are present, a noise-masking sound that prevents or substantially prevents the target sound from being heard is emitted from the speaker (see, for example, Unexamined Japanese Patent Application Publication No. 2019-83408).

### SUMMARY OF THE INVENTION

The present disclosure aims to provide an audio system. This audio system includes: a first-seat speaker positioned near a first seat in an automobile; a microphone positioned near a head of a user sitting in the first seat; a second-seat speaker positioned near a second seat in the automobile; a first-seat audio source configured to output a first audio signal; a masking noise source configured to output a predetermined noise signal as a masking noise signal; an audio signal processing device configured to combine the first audio signal from the first-seat audio source and the masking noise signal from the masking noise source together, and output a first combined signal to the first-seat speaker; and a second-seat audio source configured to output a second audio signal to be emitted from the second-seat speaker.

The audio signal processing device includes: a cross-talk detection part configured to extract a cross-talk signal, the cross-talk signal being a component of the second audio signal included in an output of the microphone and; a noise detection part configured to extract a noise signal from the output of the microphone, the noise signal not including the component of the second audio signal or a component of a sound emitted from the first-seat speaker, and including a noise component that does not relate to the audio system; a gain determining part configured to determine an amount of gain adjustment for the masking noise signal such that the masking noise signal is at a predetermined level greater than a difference in magnitude between the cross-talk signal and the noise signal; a gain adjustment part configured to adjust a gain of the masking noise signal output from the masking noise source based on the amount of gain adjustment determined by the gain determining part; and a combining part configured to combine the masking noise signal after gain adjustment in the gain adjustment part and the first audio signal output from the first-seat audio source together, and output a second combined signal to the first-seat speaker.

### BRIEF DESCRIPTION OF THE DRAWINGS

FIG. 1 shows an example structure of an audio system according to an embodiment of the present disclosure;

FIG. 2 shows example positioning of microphones and speakers according to the embodiment of the present disclosure;

FIG. 3 shows an example structure of a cross-talk detection part according to the embodiment of the present disclosure;

FIG. 4 shows an example structure of a noise detection part according to the embodiment of the present disclosure;

FIG. 5 shows example structures of a band gain adjustment part and a mixer part according to the embodiment of the present disclosure; and

FIG. 6 shows an example structure of an audio system according to another embodiment of the present disclosure.

### DETAILED DESCRIPTION OF THE DISCLOSURE

For example, assuming that two users are respectively sitting in the driver's seat and the passenger's seat in an automobile and listening to different music, it is desirable if either user hears only the music he/she wants to listen to, while being unable to hear the music the other person is listening to. To address this issue, for example, a masking sound may be output to one user to mask the music the other user is listening to. Meanwhile, environmental noise (or background noise) such as road noise and engine noise may be heard in the automobile. From one user's perspective, this environmental noise may work as a masking sound that masks the music the other user is listening to. Furthermore, the level of environmental noise may change depending on the automobile's driving conditions.

The masking sound therefore needs to be output at an adequate level that is comparable to changes in environmental noise; otherwise, the masking sound's level will be inadequate, either excessive or insufficient. In view of the foregoing, the present disclosure aims to output a masking sound to one user in the automobile, at an adequate level that is comparable to environmental noise, so as to mask the music the other user is listening to.

According to the present disclosure, an audio system can output masking noise that is directed to a user sitting in a first seat and that masks a second audio signal directed to another user sitting in a second seat, and, in doing so, adjust the level of the masking noise to an adequate level that is comparable to both the level of environmental noise that does not relate to the audio system such as road noise, and the level of the second audio signal directed to the second seat yet leaking over to the first seat.

In other words, according to the present disclosure, a masking sound can be output to one user in an automobile, at an adequate level that is comparable to environmental noise, so as to mask the music another user is listening to.

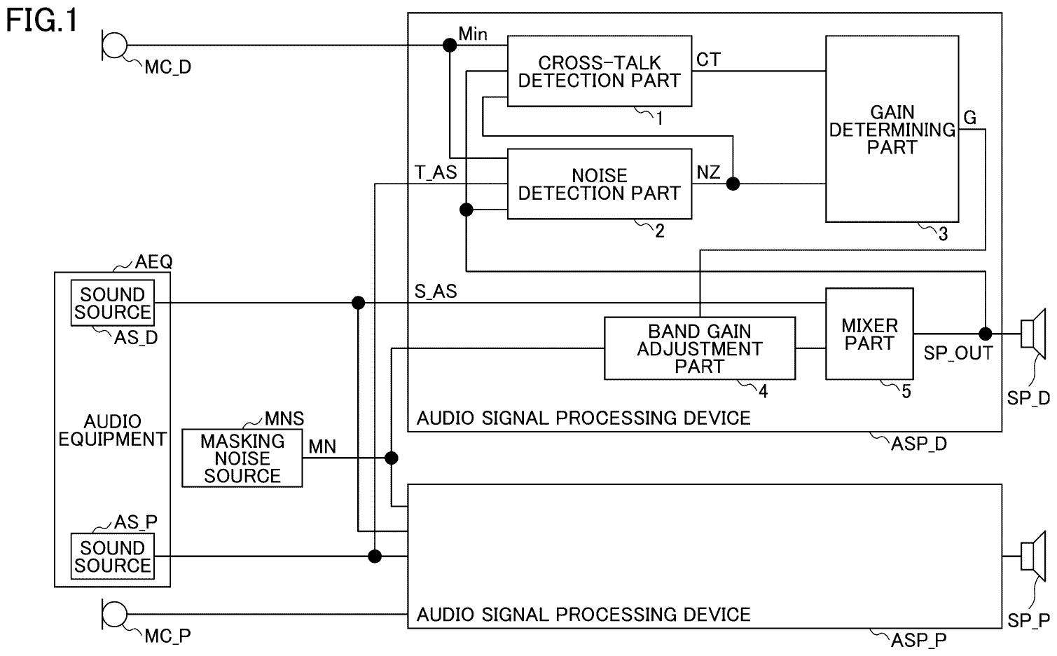

An embodiment of the present disclosure will be described below. FIG. 1 shows an example structure of an audio system according to the present embodiment. The audio system can be installed in an automobile. As shown in FIG. 1, the audio system includes: a microphone MC_D for the driver's seat; a microphone MC_P for a passenger's seat; audio equipment AEQ; a speaker SP_D for the driver's seat; a speaker SP_P for the passenger's seat; a masking noise source MNS; an audio signal processing device ASP D for the driver's seat; and an audio signal processing device ASP_P for the passenger's seat.

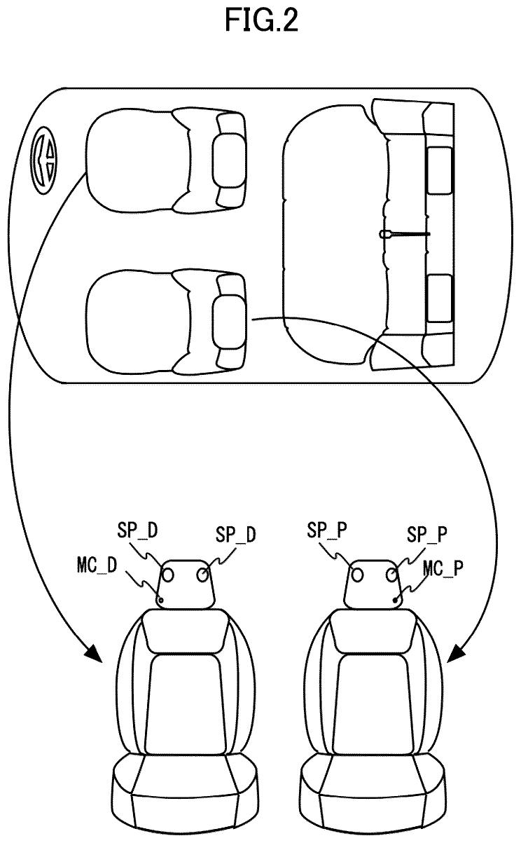

As shown in FIG. 2, the microphone MC_D for the driver's seat and the speakers SP D for the driver's seat may be positioned near the head of the user sitting in the driver's seat. For example, they may be positioned in the headrest of the driver's seat. The microphone MC_P for the passenger's seat and the speakers SP_P for the passenger's seat may be positioned near the head of the user sitting in the passenger's seat. For example, they may be positioned in the headrest of the passenger's seat.

Referring back to FIG. 1, the audio equipment AEQ function both as an audio source AS_D for the driver's seat and as an audio source AS_P for the passenger's seat. Here, the audio source AS_D for the driver's seat, the audio signal processing device ASP D for the driver's seat, and the speakers SP D for the driver's seat are structures for the driver's seat. The audio source AS_P for the passenger's seat, the audio signal processing device ASP_P for the passenger's seat, and the speakers SP_P for the passenger's seat are structures for the passenger's seat.

Among these structures, the masking noise source MNS outputs a noise signal of a predetermined level as a masking noise signal MN. For this masking noise signal MN, for example, a pink noise signal or a red (brown) noise signal may be used. An audio signal such as music is output from the audio source AS D for the driver's seat and combined with the masking noise signal MN output from the masking noise source MNS in the audio signal processing device ASP_D for the driver's seat, and the combined signal is sent to the speakers SP_D for the driver's seat. Likewise, an audio signal such as music is output from the audio source AS_P for the passenger's seat and combined with the masking noise signal MN output from the masking noise source MNS in the audio signal processing device ASP_P for the passenger's seat, and the combined signal is sent to the speakers SP_P for the passenger's seat.

The audio signal processing device ASP D for the driver's seat and the audio signal processing device ASP_P for the passenger's seat are structured alike and operate alike. Here, the structure of the audio signal processing device ASP_D for the driver's seat will be described below as an example. As shown in FIG. 1, the audio signal processing device ASP D has a cross-talk detection part 1, a noise detection part 2, a gain determining part 3, a band gain adjustment part 4, and a mixer part 5. The band gain adjustment part 4 may be what is known as an equalizer. When the masking noise source MNS outputs a masking noise signal MN, its gain is adjusted for every ⅓ octave band, according to gain control signals G output from the gain determining part 3, and the resulting making noise signal MN is output to the mixer part 5. Using an output of the audio source AS D for the driver's seat as an audio signal S AS, the mixer part 5 combines the output from the band gain adjustment part 4 and the audio signal S_AS together, and outputs the resulting output signal SP_OUT to the speakers SP D for the driver's seat. In the cross-talk detection part 1, an output of the audio source AS_P for the passenger's seat is used as an audio signal T_AS and an output of the microphone MC_D for the driver's seat is used as a microphone input signal Min, and the component corresponding to the audio signal T_AS is extracted from the microphone input signal Min as a cross-talk signal CT. In the noise detection part 2, components of the microphone input signal Min, not including the component of the audio signal T_AS and the component of the output signal SP_OUT, are extracted as a noise signal NZ. This noise signal NZ includes environmental noise components that are not related to the audio system, such as road noise. The gain determining part 3 determines gains for the band gain adjustment part 4 every ⅓ octave band such that the masking noise signal MN output from the band gain adjustment part 4 after gain adjustment is at a predetermined level greater than the level difference between the cross-talk signal CT and the noise signal NZ, and outputs gain control signals G for controlling the gains in the band gain adjustment part, for every gain determined thereby.

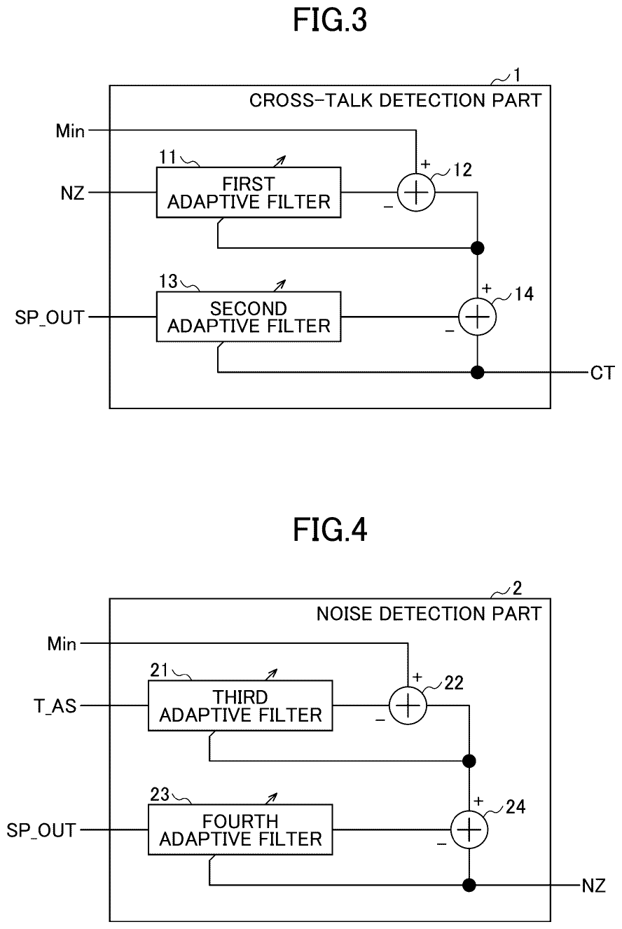

Next, FIG. 3 shows an example structure of the cross-talk detection part 1. As shown in FIG. 3, the cross-talk detection part 1 has a first adaptive filter 11, a first adder 12, a second adaptive filter 13, and a second adder 14. The first adaptive filter 11 receives the noise signal NZ as an input. The first adder 12 subtracts an output of the first adaptive filter 11 from the microphone input signal Min and outputs the result. The first adaptive filter 11 sets its transfer function (filter coefficients) such that the output of the first adder 12 is minimized. In other words, the output of the first adder 12 is the microphone input signal Min minus the noise signal NZ component. Next, the second adaptive filter 13 receives the output signal SP_OUT from the mixer part 5 as an input. The second adder 14 subtracts an output of the second adaptive filter 13 from the output of the first adder 12 and outputs the result. The second adaptive filter 13 sets its transfer function (filter coefficients) such that the output of the second adder 14 is minimized. The output of the second adder 14 is therefore the microphone input signal Min minus the noise signal NZ component and the output signal SP_OUT component (which may be an interference component from the speakers SP_D for the driver's seat). In other words, the output of the second adder 14 is a signal taken from the microphone input signal Min and representing the audio signal T_AS component (cross-talk component). This signal is output as the cross-talk signal CT.

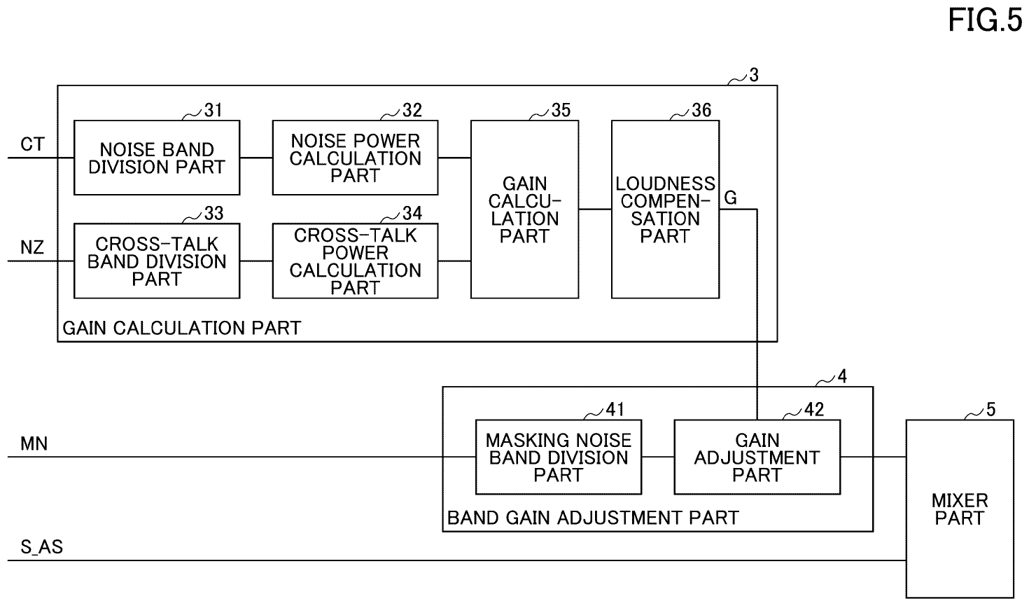

Next, FIG. 4 shows an example structure of the noise detection part 2. As shown in FIG. 4, the noise detection part 2 has a third adaptive filter 21, a third adder 22, a fourth adaptive filter 23, and a fourth adder 24. The third adaptive filter 21 receives the audio signal T_AS as an input. The third adder 22 subtracts an output of the third adaptive filter 21 from the microphone input signal Min and outputs the result. The third adaptive filter 21 sets its transfer function (filter coefficients) such that the output of the third adder 22 is minimized. The output of the third adder 22 is therefore the microphone input signal Min minus the audio signal T_AS component. Next, the fourth adaptive filter 23 receives the output signal SP_OUT from the mixer part 5 as an input. The fourth adder 24 subtracts an output of the fourth adaptive filter 23 from the output of the third adder 22 and outputs the result. The fourth adaptive filter 23 sets s its transfer function (filter coefficients) such that the output of the fourth adder 24 is minimized. The output of the fourth adder 24 is therefore the microphone input signal Min minus the audio signal T_AS component (which may be a “leakage” component from the audio source AS_P for the passenger's seat) and the output signal SP_OUT component (which may be an interference component from the speakers SP_D for the driver's seat). In other words, the output of the fourth adder 24 is a signal taken from the microphone input signal Min and representing environmental noise components. This signal is output as the noise signal NZ.

Next, FIG. 5 shows example structures of the gain determining part 3 and the band gain adjustment part 4. As shown in FIG. 5, the gain determining part 3 has a noise band division part 31, a noise power calculation part 32, a cross-talk band division part 33, a cross-talk power calculation part 34, a gain calculation part 35, and loudness compensation part 36. The noise band division part 31 divides the noise signal NZ into ⅓ octave bands, and the noise power calculation part 32 calculates the power of the noise signal NZ per divided band. The cross-talk band division part 33 divides the cross-talk signal CT into ⅓ octave bands, and the cross-talk power calculation part 34 calculates the power of the cross-talk signal CT per divided band. For each divided band, the gain calculation part 35 calculates the gain for use in the band gain adjustment part 4 such that the masking noise signal MN output from the band gain adjustment part 4 after gain adjustment is at a predetermined level greater than the level difference between the cross-talk signal CT and the noise signal NZ (for example, greater by 1 dB). In other words, gains for use in the band gain adjustment part 4 are calculated such that the sum level of every masking noise signal MN output from the band gain adjustment part 4 after gain adjustment and the corresponding noise signal NZ is at a predetermined level greater than the level of the cross-talk signal CT (for example, greater by 1 dB). To calculate the gains for the band gain adjustment part 4 thereby, the level of each band forming the masking noise signal MN output from the masking noise source MNS is needed, and therefore set in the gain calculation part 35 in advance. The loudness compensation part 36 corrects the gains calculated in the gain calculation part 35 such that the difference in auditory loudness between sounds corresponding to respective bands is alleviated, and the sum of the loudness of the masking noise signal MN and the loudness of the noise signal NZ per band, as perceived/heard by the user in the driver's seat, is at a predetermined level greater than the loudness of the cross-talk signal CT. The corrected gains are output to the band gain adjustment part 4 as gain control signals G. Next, the band gain adjustment part 4 has a masking noise band division part 41 and a gain adjustment part 42. The masking noise band division part 41 divides the masking noise signal MN output from the masking noise source MNS into ⅓ octave bands. The gain adjustment part adjusts the gain of the masking noise signal MN per divided band, according to the gain control signals G input from the loudness compensation part 36. After the masking noise signal MN undergoes gain adjustment on a per divided band the resulting signals basis, corresponding to respective bands are combined and output to the mixer part 5.

The audio signal processing device ASP D for the driver's seat has been described above. The above description of the audio signal processing device ASP D for the driver's seat may sufficiently illustrate the audio signal processing device ASP_P for the passenger's seat as well, except that: the driver's seat and the passenger's seat need to be swapped; the microphone MC_D for the driver's seat needs to be replaced with a microphone MC P for the passenger's seat; the speakers SP_D for the driver's seat need to be replaced with speakers SP P for the passenger's seat; and the audio source AS_D for the driver's seat needs to be replaced with an audio source AS_P for the passenger's seat.

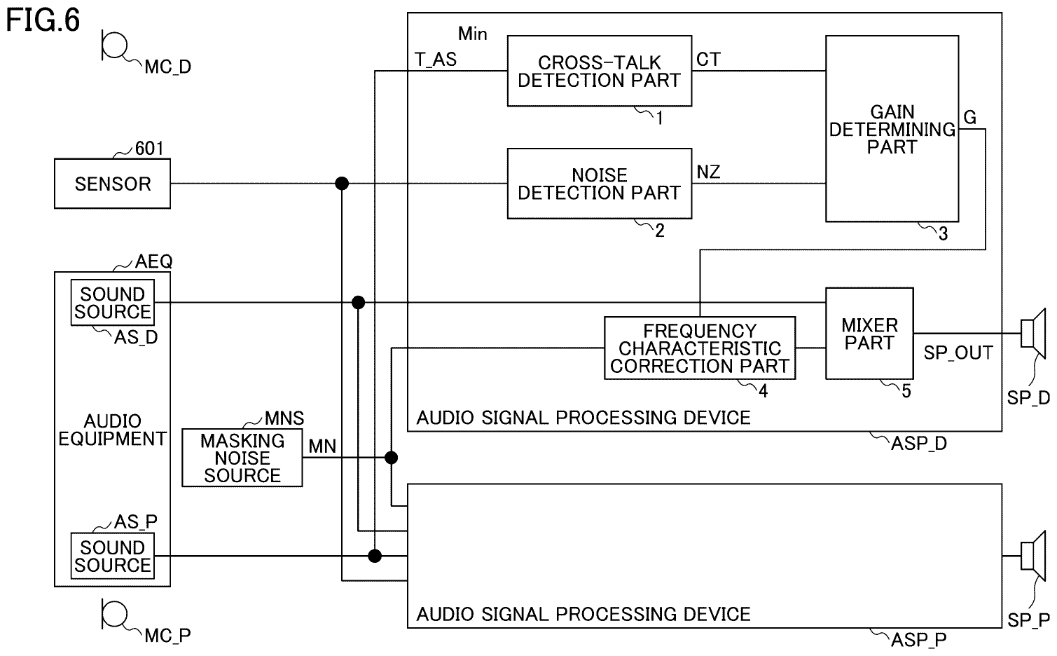

An embodiment of the present disclosure has been described above. The audio system described above may be structured as shown in FIG. 6. This audio system includes a sensor 601 that detects, for example, the acceleration of the automobile's vibration. Referring to FIG. 6, the cross-talk detection part 1 for the audio signal processing device AP_D for the driver's seat generates a cross-talk signal CT by convolving an output of the audio source AS_P for the passenger's seat with the transfer function from the audio source AS_P for the passenger's seat, to the head position of the user sitting in the driver's seat, via the speakers SP P for the passenger's seat, which is learned in advance. The cross-talk detection part 1 for the audio signal processing device AP_P for the passenger's seat generates a cross-talk signal CT by convolving an output of the audio source AS_D for the driver's seat with the transfer function from the audio source AS_D for the driver's seat, to the head position of the user sitting in the passenger's seat, via the speakers SP_D for the driver's seat, which is learned in advance.

As for the transfer function from the audio source AS_P for the passenger's seat to the head position of the user sitting in the driver's seat, the transfer function of the output of the audio source AS_P for the passenger's seat to the microphone MC_D for the driver's seat via the speakers SP_P for the passenger's seat may be learned in advance. Similarly, as for the transfer function from the audio source AS_D for the driver's seat to the head position of the user sitting in the passenger's seat, the transfer function of the output of the audio source AS_D for the driver's seat to the microphone MC_P for the passenger's seat via the speakers SP_D for the driver's seat may be learned in advance.

In addition, the noise detection part 2 in the audio signal processing device AP_D and/or ASP_P estimates environmental noise from values detected by the sensor 601 and outputs a noise signal NZ representing an estimate of environmental noise. To estimate environmental noise from values detected by the sensor 601, the relationship between the acceleration of the automobile's vibration and road noise may be learned in advance, so that, once the sensor 601 detects an acceleration of the automobile's vibration, the road noise can be estimated.

To learn the relationship between the acceleration of vibration and road noise in advance, for example, an adaptive filter that converts acceleration into road noise may be configured such that the difference between actual road noise picked up by a given microphone and the adaptive filter's output is minimized. In this case, the adaptive filter is configured to receive an acceleration of the automobile's vibration detected by the sensor 601 as an input, and output an estimate of road noise. Alternatively, to learn the relationship between the acceleration of the automobile's vibration and road noise in advance, the correspondence between the acceleration of vibration and actual road noise picked up by a given microphone is determined in advance and compiled into a table. In this case, when the sensor 601 detects that the automobile is vibrating at a certain rate of acceleration, the road noise associated with that rate of acceleration in the table may be used as an estimate of road noise.

Here, the noise detection part 2 may detect environmental noise that further takes an estimate of engine noise into account. In this case, to estimate engine noise, the sensor 601 is configured to detect the automobile's engine speed (for example, the number of revolutions per minute (RPM)), and the relationship between engine speed and engine noise may be learned in advance, so that, when the sensor 601 detects a certain value of engine speed, the engine noise can be estimated from that engine speed. Assuming that an adaptive filter converts a periodic wave having a rotation period that is the same as the engine speed, or a periodic wave in which the rotation period of the engine speed is 1/the number of cylinders (e.g., a sine wave), into engine noise, the relationship between engine speed and engine noise can be learned in advance by, for example, configuring this adaptive filter such that the difference between actual engine noise picked up by a given microphone and the adaptive filter's output is minimized. For example, the sensor 601 detects a certain engine speed, and, based on this engine speed, a periodic wave having a rotation period that is the same as the engine speed or a periodic wave in which the rotation period of the engine speed is 1/the number of cylinders (e.g., a sine wave) is generated and input to the adaptive filter, and the adaptive filter outputs an estimate of engine noise. Thus, according to the audio system of FIG. 6, the microphone MC_D for the driver's seat and the microphone MC_P for the passenger's seat may be unnecessary, at least while the audio system is operating. One of the cross-talk detection part 1 and the noise detection part 2 in the audio system shown in FIG. 6 may be replaced with a corresponding detection part, namely one of the cross-talk detection part 1 and the noise detection part 2 in the audio system shown in FIG. 2.

Note that either the audio signal processing device ASP_D for the driver's seat or the audio signal processing device ASP_P for the passenger's seat may be implemented using electronic for circuitry including, example, a central processing unit (CPU), a graphics processing unit (GPU), a digital signal processor (DSP), a field programmable gate array (FPGA), and/or an application specific integrated circuit (ASIC). These components execute a variety of processes described in this specification by, for example, executing instruction codes stored in a memory, providing circuitry designed for a particular application, and so forth.

As described above, according to the present embodiment, one of the driver's seat and the passenger's seat in an automobile is a first seat and the other seat is a second seat, the level of masking noise for masking a second audio signal directed to the user sitting in the second seat for the user sitting in the first seat can be adjusted to an adequate level that is comparable to both the level of environmental noise that does not relate to the audio system such as road noise and the level of cross-talk produced due to the second audio signal directed to the second seat yet leaking over to the first seat.

In addition, the driver's seat and the passenger's seat in the above embodiment may be replaced with any two seats in an automobile.

What is claimed is:

1. An audio system comprising:
a first-seat speaker positioned near a first seat in an automobile;
a microphone positioned near a head of a user sitting in the first seat;
a second-seat speaker positioned near a second seat in the automobile;
a first-seat audio source configured to output a first audio signal;
a masking noise source configured to output a predetermined noise signal as a masking noise signal;
a second-seat audio source configured to output a second audio signal to be emitted from the second-seat speaker; and
audio signal processing circuitry configured to:
extract a cross-talk signal, the cross-talk signal being a component of the second audio signal included in an output of the microphone;
extract a noise signal from the output of the microphone, the noise signal not including the component of the second audio signal or a component of a sound emitted from the first-seat speaker, and including a noise component that does not relate to the audio system;
determine an amount of gain adjustment for the masking noise signal such that the masking noise signal is at a predetermined level greater than a difference in magnitude between the cross-talk signal and the noise signal;
perform gain adjustment to adjust a gain of the masking noise signal output from the masking noise source based on the determined amount of gain adjustment; and
generate a combined signal by combining the masking noise signal after the gain adjustment and the first audio signal output from the first-seat audio source together, and output the combined signal to the first-seat speaker.

2. The audio system according to claim 1, wherein the cross-talk signal is generated by removing, from the output of the microphone, the component of the noise signal and a component of the combined signal output to the first-seat speaker.

3. The audio system according to claim 1, wherein the noise signal is generated by removing, from the output of the microphone, the component of the second audio signal and a component of the combined signal output to the first-seat speaker.

4. The audio system according to claim 1,
wherein the cross-talk signal is generated by removing, from the output of the microphone, the component of the noise signal and a component of the combined signal output to the first-seat speaker, and
wherein the noise signal is generated by removing, from the output of the microphone, the component of the second audio signal and the component of the combined signal output to the first-seat speaker.

5. An audio system comprising:
a first-seat speaker positioned near a first seat in an automobile;
a second-seat speaker positioned near a second seat in the automobile;
a first-seat audio source configured to output a first audio signal;
a masking noise source configured to output a predetermined noise signal as a masking noise signal;
a second-seat audio source configured to output a second audio signal to be emitted from the second-seat speaker; and
audio signal processing circuitry configured to:
detect a behavior of the automobile;
generate a cross-talk signal by convolving the second audio signal with a predetermined transfer function from the second-seat audio source to a head position of a user sitting in the first seat;
generate, as the noise signal, a signal that represents noise and that is chosen based on a predetermined relationship between the behavior of the automobile and noise that does not relate to the audio system;
determine an amount of gain adjustment for the masking noise signal such that the masking noise signal is at a predetermined level greater than a difference in magnitude between the cross-talk signal and the noise signal;
perform gain adjustment to adjust a gain of the masking noise signal output from the masking noise source based on the determined amount of gain adjustment; and
generate a combined signal by combining the masking noise signal after the gain adjustment and the first audio signal output from the first-seat audio source together, and output a combined signal to the first-seat speaker.

6. The audio system according to claim 5,
wherein the behavior of the automobile is acceleration of vibration of the automobile, and
wherein the noise is road noise.

7. The audio system according to claim 1,
wherein the amount of noise adjustment for the masking noise signal is determined per predetermined band of the masking noise signal, such that the masking noise signal is at the predetermined level greater than the difference in magnitude between the cross-talk signal and the noise signal, and
wherein the gain of the masking noise signal output from the masking noise signal source is adjusted per predetermined band of the masking noise signal, based on the determined amount of gain adjustment.

8. The audio system according to claim 7, wherein the amount of gain adjustment for the masking noise signal is determined per predetermined band of the masking noise signal, such that auditory loudness of a sound combining a sound corresponding to the masking noise signal and a sound corresponding to the noise signal as heard is the predetermined level greater than auditory loudness of the sound corresponding to the noise signal.
